(19) United States
(12) Patent Application Publication
(10) Pub. No.: US 2018/0097918 A1
(43) Pub. Date: Apr. 5, 2018

(54) Segmentation and Concatenation for New Radio Systems

(71) Applicant: MEDIATEK INC., Hsinchu (TW)

(72) Inventors: Pavan Santhana Krishna Nuggehalli, San Carlos, CA (US); Chia-Chun Hsu, New Taipei City (TW); Ming-Yuan Cheng, Taipei City (TW)

(21) Appl. No.: 15/719,551

(22) Filed: Sep. 29, 2017

Related U.S. Application Data
(60) Provisional application No. 62/401,988, filed on Sep. 30, 2016.
(60) Provisional application No. 62/443,005, filed on Jan. 6, 2017.

(51) Int. Cl. H04L 29/08; H04W 28/06; H04L 5/00; H04L 29/06; H04L 12/835

(52) U.S. Cl. CPC H04L 69/324; H04W 28/065; H04L 5/0046; H04L 69/32; H04L 47/30; H04L 69/166; H04L 69/16; H04L 69/22

(57) ABSTRACT

Methods of segmentation and concatenation for new radio user plane are proposed. For high speed data traffic, all PDCP PDUs are segmented into fixed-length segments at RLC layer. The MAC layer can then concatenate these segments based on real time uplink grants. Under this mechanism, segmentation related header fields can be pre-computed since they are not dependent on the uplink grant process. For low data rate with small packet size traffic, a solution of PDCP layer concatenation is proposed to reduce protocol overhead. Multiple PDCP SDUs are concatenated into a single PDCP PDU. The level of PDCP concatenation is configured by the base station or implemented by the UE.

### CROSS REFERENCE TO RELATED APPLICATIONS

This application claims priority under 35 U.S.C. § 119 from U.S. Provisional Application No. 62/401,988 entitled “Segmentation and Concatenation for NR UP” filed on Sep. 30, 2016; U.S. Provisional Application No. 62/443,005 entitled “Concatenation at PDCP” filed on Jan. 6, 2017, the subject matter of which is incorporated herein by reference.

### TECHNICAL FIELD

The disclosed embodiments relate generally to wireless communication, and, more particularly, to segmentation and concatenation for new radio (NR) systems with LTE-WAN aggregation (LWA).

### BACKGROUND

Mobile data usage has been increasing at an exponential rate in recent years. A Long-Term Evolution (LTE) system offers high peak data rates, low latency, improved system capacity, and low operating cost resulting from simplified network architecture. In LTE systems, an evolved universal terrestrial radio access network (E-UTRAN) includes a plurality of base stations, such as evolved Node-B′s (eNBs) communicating with a plurality of mobile stations referred as user equipment (UEs). However, the continuously rising demand for data traffic requires additional solutions. Interworking between the LTE network and the unlicensed spectrum WLAN provides additional bandwidth to the operators.

The Next Generation Mobile Network (NGMN) Board, has decided to focus the future NGMN activities on defining the end-to-end (E2E) requirements for 5G. Three main applications in 5G include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Specifically, the design requirements for 5G includes maximum cell size requirements and latency requirements. The maximum cell size is urban micro cell with inter-site distance (ISD)=500 meters, i.e. cell radius is 250˜300 meters. For eMBB, the E2E latency requirement is <=10 ms; for URLLC, the E2E latency is <=1 ms. Furthermore, multiplexing of eMBB & URLLC within a carrier should be supported, and TDD with flexible UL/DL ratio is desirable.

It was recognized that LTE user plane (UP) protocol stack may not be able to handle new radio (NR) requirements for eMBB usage scenario including: data rates of 20 Gbps/10 Gbps in DL/UL, UP latency of 4ms in both UL and DL, and the use of shorter TTI. This is because the LTE UP has several shortcomings. In LTE, the time to process RLC and MAC headers is tied to the uplink grant process. For 10 Gbps UL, the RLC layer needs to generate approximately 833 L1 fields every 1 ms (assuming 1500 byte PDCP PDU). LTE RLC header further imposes serial processing. The E bit is used to indicate the presence of additional L1 fields. Accordingly, it has been observed that, for high data rates, reducing protocol related processing is likely to be more beneficial than simply reducing overhead for highspeed NR UP design. In addition, real time computation of RLC/MAC header to support segmentation can be a performance bottleneck for high data rates.

However, for low data rates (e.g., VoIP or MTC scenarios), protocol overhead can be significant. For example, assuming the VoIP packets are compressed to 35 bytes, the protocol overhead in LTE and NR can reach as high as 10.3%. Apart from VoIP, there are several scenarios involving low data rate traffic carrying small-sized data packets. For example, on enhancements for diverse data application (eDAA), a significant fraction of UL and DL traffic consists of packets of size between 40 and 100 bytes. A general analysis with 25 byte and 50 byte packet size shows that the protocol overhead with no PDCP concatenation can reach as high as 13.8%. Therefore, as compared to LTE where multiple PDCP SDUs can be packed into a single MAC PDU, the protocol overhead with NR is quite large with no concatenation.

### SUMMARY

Methods of segmentation and concatenation for new radio user plane are proposed. For high speed data traffic, all PDCP PDUs are segmented into fixed-length segments at RLC layer. The MAC layer can then concatenate these segments based on real time uplink grants. Under this mechanism, segmentation related header fields can be pre-computed since they are not dependent on the uplink grant process. For low data rate with small packet size traffic, a solution of PDCP layer concatenation is proposed to reduce protocol overhead. Multiple PDCP SDUs are concatenated into a single PDCP PDU. The level of PDCP concatenation is configured by the base station or implemented by the UE.

In one embodiment, a UE establishes a connection with a base station in a wireless network. The UE pre-concatenates a plurality of packet data convergence protocol (PDCP) layer protocol data units (PDUs) into a plurality of radio link control (RLC) layer PDUs. Each RLC layer PDU has a fixed-length configured via a higher layer signaling. The UE receives an uplink grant over a physical layer signaling from the base station. The uplink grant allocates a size for uplink radio resource. Finally, the UE concatenates the RLC layer PDUs into media access control (MAC) layer PDUs based on the size of the uplink grant.

In another embodiment, a UE establishes a connection with a base station in a wireless network. The UE and the base stations exchange data traffic with a low data rate and/or a small packet size. The UE concatenates a plurality of IP packets into a single packet data convergence protocol (PDCP) layer protocol data unit (PDU). A level of PDCP concatenation indicates a number of IP packets to be concatenated in the single PDCP PDU, and the level of PDCP concatenation is configured by the base station or implemented by the UE. The UE performs downlink reception or uplink transmission based on a downlink/uplink scheduling over a physical layer signaling from the base station.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a new radio (NR) mobile communication network with LTE-WAN aggregation (LWA) in accordance with embodiments of the current invention.

FIG. 2 illustrates simplified block diagram of a user equipment in accordance with embodiments of the current invention.

FIG. 3 illustrates a sequence flow between a base station and a user equipment that supports RLC layer pre-concatenation and PDCP layer concatenation in accordance with embodiments of the present invention.

FIG. 4 illustrates one embodiment of RLC layer pre-concatenation for high speed data traffic.

FIG. 5 illustrates one embodiment of PDCP layer concatenation for low data rate and/or with small packet size data traffic.

FIG. 6 illustrates a high-level overview of PDCP layer concatenation.

FIG. 7 is a flow chart of a method of pre-concatenation for high speed data traffic in accordance with one novel aspect.

FIG. 8 is a flow chart of a method of PDCP concatenation for low data rate and/or small packet size in accordance with one novel aspect.

### DETAILED DESCRIPTION

Reference will now be made in detail to some embodiments of the invention, examples of which are illustrated in the accompanying drawings.

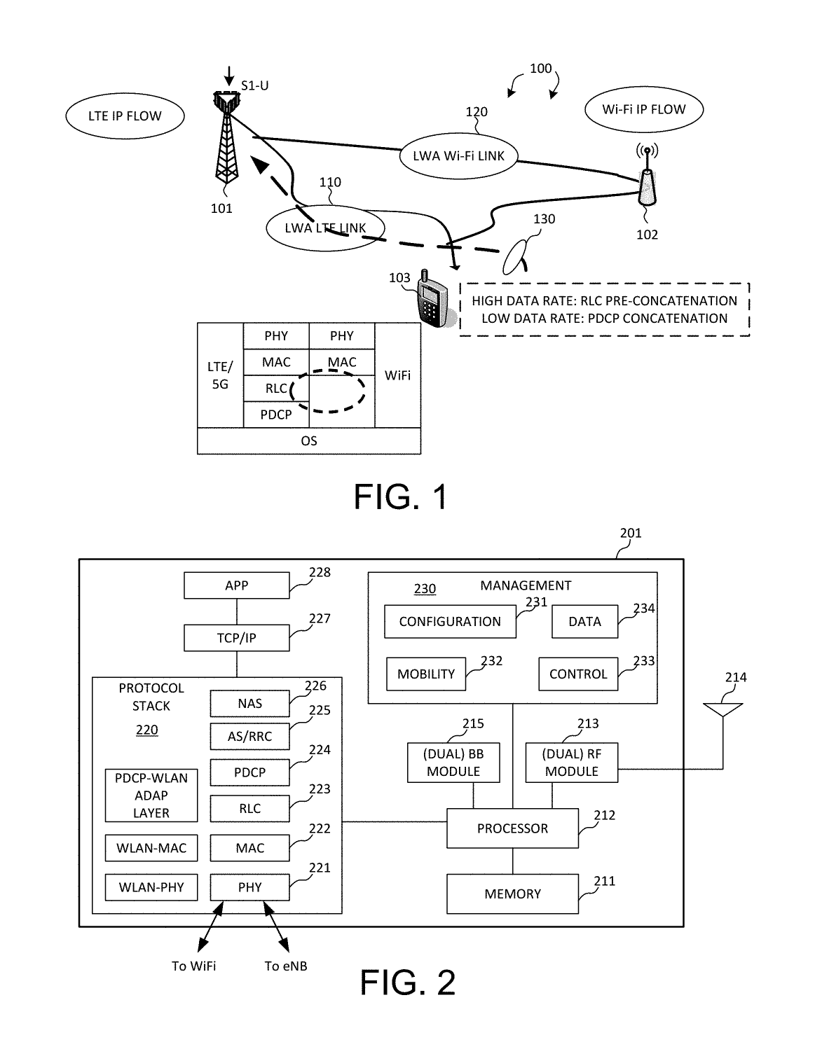

FIG. 1 illustrates a system diagram of a new radio (NR) mobile communication network 100 with LTE-WLAN aggregation (LWA) in accordance with embodiments of the current invention. Wireless network 100 comprises a base station eNB 101 that provides LTE/5G cellular radio access via E-UTRAN, an access point AP 102 that provides Wi-Fi radio access via WLAN, and a user equipment UE 103. LTE-WLAN Aggregation (LWA) is a tight integration at radio level, which allows for real-time channel and load-aware radio resource management across LTE and WLAN to provide significant capacity and Quality of Experience (QoE) improvements. When enabling LWA, S1-U interface is terminated at eNB 101 whereby all IP packets are routed to eNB 101 and performed with packet data convergence protocol (PDCP) layer operations as an LTE PDU. Afterwards, eNB 101 schedule whether LWA-LTE link 110 or LWA-Wi-Fi link 120 the LTE PDU shall go.

In the example of FIG. 1, IP packets are carried between a serving gateway and eNB 101 over the S1-U interface. The LWA capable eNB 101 performs legacy PDCP layer operations such as ciphering and header compression (ROHC). In addition, the LWA capable eNB 101 is responsible for aggregating data flows over the LTE and WLAN air-interfaces. For example, the PDCP entity of the LWA capable eNB 101 performs traffic splitting, floor control, and new PDCP header handling for LWA packets received from the serving gateway. In the downlink, eNB 101 can schedule a few PDCP PDUs over LTE access and the remaining over WLAN access. The PDCP entity of the LWA capable UE 103 buffers the PDCP PDUs received over LTE and WLAN air interfaces and performs appropriate functions such as traffic converging and reordering, new PDCP header handling, and legacy PDCP operation. Similar functionality is also required for the uplink 130.

Segmentation and concatenation are essential to ensure that radio resources received via uplink grants are efficiently consumed the UE. However, in LTE, the procedures for segmentation and concatenation need to happen in real time because radio link control (RLC) and media access control (MAC) PDUs are constructed based on uplink grant size. At the high speeds at which enhanced Mobile Broadband (eMBB) NR user plane (UP) is supposed to operate (e.g., 20 Gbps DL and 10 Gbps UL), simplifying TX/RX processing is likely to be more important than saving on PDU header overhead. This situation is further exacerbated by the reduced target UP latency value (e.g., 4 ms for UL and DL), and potential reduction in transmission time interval (TTI) length.

All the current proposals on moving concatenation from RLC to MAC require segmentation of at least some packets on a real-time basis. Moving the segmentation function from RLC to MAC layer, by itself, does not result in reducing processing burden since the MAC PDU is constructed based on the received UL grant. Since segmentation causes header information to be computed, it can be a bottleneck for high speed operation. In accordance with a novel aspect, all PDCP PDUs are segmented into fixed-length segment at RLC layer. The MAC layer can then concatenate these segments based on UL grants. Under this mechanism, segmentation related header fields can be pre-computed since they are not dependent on the uplink grant process.

For low data rates (e.g., VoIP or MTC scenarios), protocol overhead can be significant. A general analysis with 25 byte and 50 byte small packet size shows that the protocol overhead with no PDCP concatenation can reach as high as 13.8%. Therefore, as compared to LTE where multiple PDCP SDUs can be packed into a single MAC PDU, the protocol overhead with NR is quite large with no PDCP layer concatenation. In accordance with one novel aspect, a solution of PDCP layer concatenation is proposed to reduce protocol overhead. Multiple PDCP SDUs are concatenated into a single PDCP PDU especially for low data rates and small packet size IP traffic.

FIG. 2 illustrates a simplified block diagram for UE 201 that carry certain embodiments of the present invention. UE 201 has an antenna (or antenna array) 214, which transmits and receives radio signals. A RF transceiver module (or dual RF modules) 213, coupled with the antenna, receives RF signals from antenna 214, converts them to baseband signals and sends them to processor 212 via baseband module (or dual BB modules) 215. RF transceiver 213 also converts received baseband signals from processor 212 via baseband module 215, converts them to RF signals, and sends out to antenna 214. Processor 212 processes the received baseband signals and invokes different functional modules to perform features in UE 201. Memory 211 stores program instructions and data to control the operations of UE 201.

UE 201 also includes a 3GPP protocol stack module/circuit 220 supporting various protocol layers including NAS 226, AS/RRC 225, PDCP 224, RLC 223, MAC 222 and PHY 221, a TCP/IP protocol stack module 227, an application module APP 228, and a management module 230 including a configuration module 231, a mobility module 232, a control module 233, and a data handling module 234. The function modules and circuits, when executed by processor 212 (via program instructions and data contained in memory 211), interwork with each other to allow UE 201 to perform certain embodiments of the present invention accordingly. In one example, each module or circuit comprises a processor together with corresponding program codes. Configuration circuit 231 obtains UP setup preference information and establishes connection, mobility circuit 232 determines UE mobility based on UE speed, movement and cell count, control circuit 233 determines and applies a preferred U-plane setup for the UE dynamically, and data handling circuit 234 performs corresponding setup activation and selection.

UE 201 is LWA-enabled. UE 201 has a PHY layer, a MAC layer, and a RLC layer that connect with an LTE eNB. UE 201 also has a WLAN PHY layer and a WLAN MAC layer that connect with a WLAN AP. A WLAN-PDCP adaption layer handles the split bearer from the LTE and the WLAN. UE 201 also has a PDCP layer entity. UE 201 aggregates its data traffic with the eNB and the AP. For LWA, both the LTE data traffic and the WLAN data traffic are aggregated at the PDCP layer of UE 201. For high speed data traffic, RLC layer pre-concatenation is enabled to reduce protocol related processing delay. For low speed and/or small packet size traffic, PDCP layer concatenation is enabled to reduce protocol overhead.

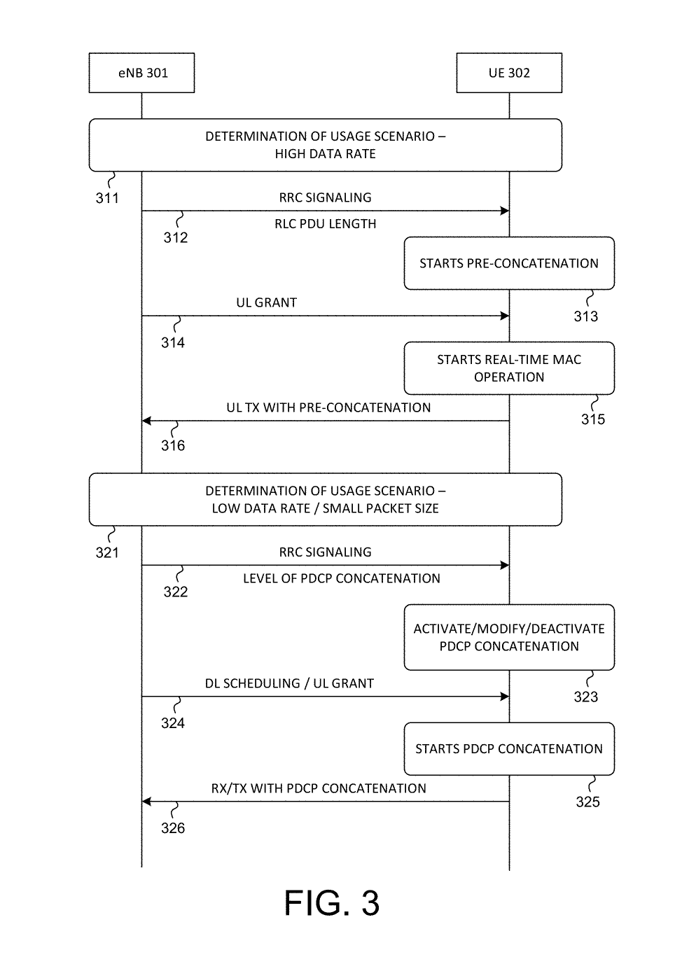

FIG. 3 illustrates a sequence flow between a base station eNB 301 and a user equipment UE 302 that supports RLC pre-concatenation and PDCP concatenation in accordance with embodiments of the present invention. In step 311, eNB 301 and UE 302 establishes a wireless connection for exchanging data traffic and determines that the usage scenario is high data rate traffic. In step 312, eNB 301 transmits a higher layer signaling, e.g., RRC signaling to UE 302. In one example, the RRC signaling configures a fixed length of RLC layer PDUs for high speed data traffic. In step 313, UE 302 starts processing application data to be transmitted to eNB 301. During the process, PDCP layer PDUs are encapsulated, concatenated, and/or segmented into RLC layer PDUs, MAC layer PDUs, and finally transmitted out over PHY layer. In order to reduce the protocol related processing delay, one mechanism is to simply segment all PDCP PDUs into fixed length segments at RLC layer. In step 314, UE 302 receives real-time uplink grants from eNB 301. In step 315, the MAC layer can then concatenate the fixed length RLC segments based on the UL grants. In step 316, UE 302 transmits processed data packets to eNB 301. In this mechanism, segmentation related header fields can be pre-computed since they are not dependent on the uplink grant process.

In step 321, eNB 301 and UE 302 establishes a wireless connection for exchanging data traffic and determines that the usage scenario is low data rate traffic and/or small packet size. In step 322, eNB 301 transmits a higher layer signaling, e.g., RRC signaling to UE 302. In one example, the RRC signaling configures a level of PDCP concatenation for low data rate traffic. In step 323, UE 302 activates, modifies, or deactivates PDCP concatenation based on the RRC configuration. In step 324, UE 302 receives real-time downlink scheduling or uplink grants from eNB 301. In step 325, UE 302 starts processing application data to be transmitted to eNB 301. During the process, IP packets are encapsulated, concatenated, and/or segmented into PDCP layer PDUs, RLC layer PDUs, MAC layer PDUs, and finally transmitted out over PHY layer. In order to reduce protocol overhead for low data rate traffic, a method of concatenation at the PDCP layer is introduced based on the level of PDCP concatenation configured by the RRC signaling or implemented by the UE. In step 326, UE 302 transmits processed data packets to eNB 301 in the uplink. Note that for downlink traffic, similar PDCP layer concatenation mechanism can be performed by eNB 301 for low data rate traffic.

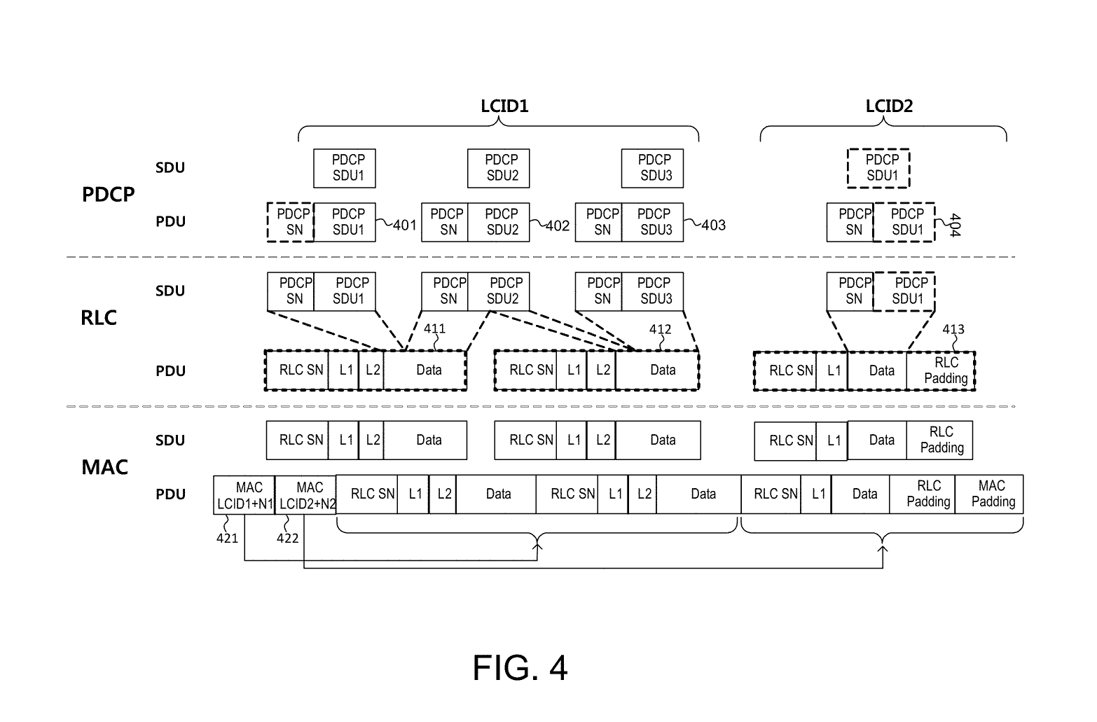

FIG. 4 illustrates one embodiment of RLC layer pre-concatenation for high speed data traffic. In this embodiment, data traffic is originated from application layer, through IP layer, PDCP layer, RLC layer, MAC layer, and to PHY layer. PDCP layer SDUs are encapsulated to PDCP layer PDUs, which become RLC layer SDUs, and then pre-concatenated into fixed-length RLC layer PDUs, which become MAC layer SDUs, and then concatenated into MAC layer PDUs based on the uplink grant size. Specifically, RLC layer encapsulates PDCP PDUs in fixed length RLC PDUs, where the length of RLC PDUs can be configured by the base station. Depending on the length of RLC PDU chosen, the encapsulation process can require segmentation and/or concatenation of PDCP PDUs.

In the example of FIG. 4, PDCP layer PDUs 401, 402, 403 and 404 are pre-concatenated to RLC layer PDUs 411, 412, and 413. Each RLC layer PDU is set to a fixed length (which could be different for each data radio bearer (DRB)). In addition to the RLC sequence number (SN), each RLC PDU also comprises length fields indicating the length of corresponding PDCP PDUs contained in the RLC data field. For example, in RLC PDU 411, field L1 indicates the length of PDCP PDU 401, field L2 indicates the length of part of PDCP PDU 402. In RLC PDU 412, field L1 indicates the length of the remaining part of PDCP PDU 402, field L2 indicates the length PDCP PDU 403. Occasionally, UE may not have sufficient data to form full length RLC PDUs. In this case, the RLC layer may use padding to deliver fixed size RLC PDUs to the MAC layer. For example, RLC PDU 413 comprises RLC padding bits. The RLC layer can construct the PDUs without any consideration of the uplink grant process. These RLC layer PDUs are then concatenated by the MAC layer depending on the received uplink grant and result of the logical channel prioritization (LCP) procedure. Padding may also be used to avoid segmentation (e.g., to save the overhead of specifying segmentation offset). The MAC layer concatenates these RLC PDUs with a single MAC subheader for each logical channel that provides the number of RLC PDUs that have been assembled. For example, the MAC PDU comprises MAC subheaders 421 and 422, N1 indicating the number of RLC PDUs for LCID1, and N2 indicating the number of RLC PDUs for LCID2.

The primary benefit of the RLC pre-concatenation is that RLC PDUs are constructed without any dependency on the uplink grant process. The ability to precompute RLC headers means the RLC processing is no longer in real time. In LTE, the MAC subheader contains a length field (for each logical channel) that can be as big as 16 bits. In the proposed scheme, the MAC layer does not perform segmentation, and the MAC subheader for each logical channel needs to only specify the number of RLC PDUs that are concatenated, simplifying the process of concatenation, and requiring considerably fewer bits.

Even though the RLC PDU size is fixed, it is worth noting that the length is configured by the base station that can provide many benefits. Some alternatives require an RLC SN assignment per IP packet which has some disadvantages. First, this design imposes the overhead of RLC SN for each IP packet and corresponding burden of RLC status reporting. Second, the rate of RLC SN space consumption increases linearly with physical layer data rates, possibly requiring extension of the RLC SN length. In the proposed scheme, an RLC PDU can contain multiple IP packets depending on the length chosen for the RLC PDU, thus requiring less RLC SN overhead. By choosing the RLC PDU length appropriately, the base station can also ensure that the SN space does not need to scale with physical layer data rates. The proposed scheme trades off potentially more overhead with simpler processing. Such a tradeoff may be particularly desirable for eMBB usage scenarios where available raw physical layer rates are much higher than LTE, and implementation complexity is a greater consideration than extremely efficient radio resource utilization.

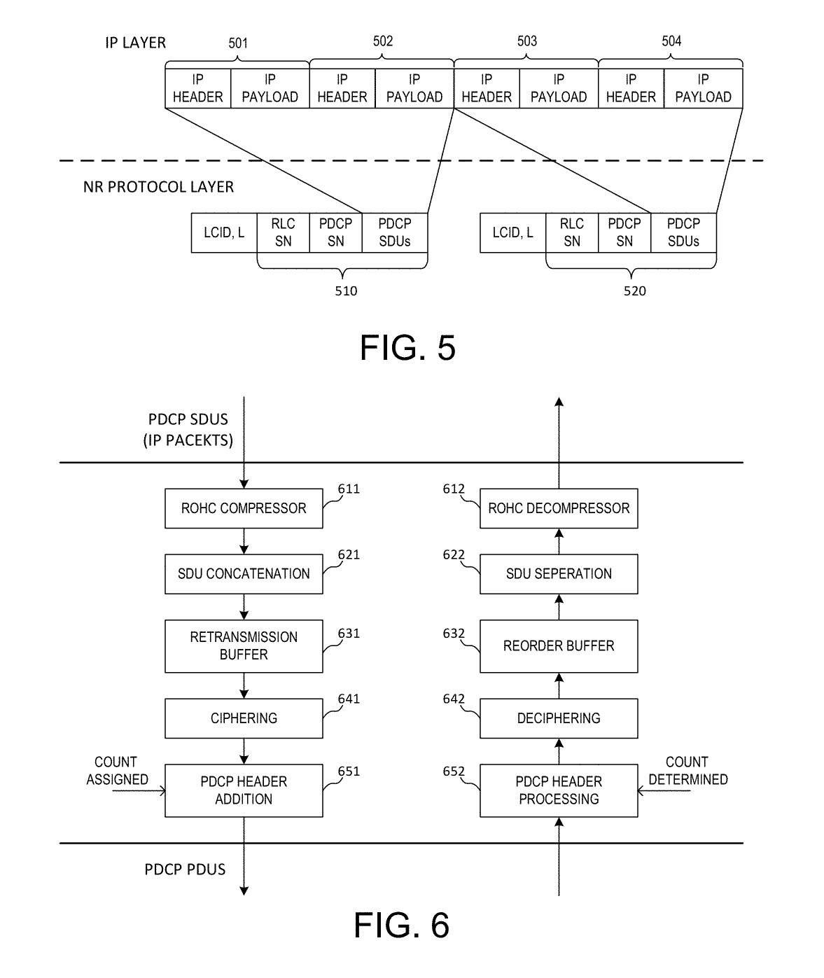

FIG. 5 illustrates one embodiment of PDCP layer concatenation for low data rate and/or small packet size data traffic. In this embodiment, data traffic is originated from application layer, through IP layer, PDCP layer, RLC layer, MAC layer, and to PHY layer. If the NR protocol does not allow concatenation at RLC layer, then concatenation at PDCP layer can reduce overhead in low data rate scenarios. Specifically, multiple IP layer packets are concatenated into a single PDCP PDU at PDCP layer. For example, two IP packets 501 and 502 are concatenated into one PDCP PDU 510, and two IP packets 503 and 504 are concatenated into one PDCP PDU 520. Such PDCP concatenation is invisible to both lower and upper layers when robust header compression (ROHC) is not configured. With ROHC, additional fields may be needed to indicate length. Some signaling is needed to ensure that the receiver knows that PDCP layer concatenation is enabled, which can be left to UE implementation or controlled by the base station via RRC or MAC CE signaling. The actual level of PDCP concatenation can be left to UE implementation or explicitly indicated by the base station. The level of PDCP concatenation can be different per DRB, and separate for UL and DL.

FIG. 6 illustrates a high-level overview of PDCP layer concatenation. At the transmitter side, for each IP flow, the UE PDCP layer performs ROHC header compression (step 611), PDCP SDU concatenation (step 621) where multiple IP packets are concatenated into a single PDCP PDU, retransmission buffering (step 631), ciphering (step 641), and PDCP header addition (step 651) where the PDCP SDU count is assigned and PDCP header is added. At the receiver side, for each IP flow, the UE PDCP layer performs PDCP header processing (step 652) where the PDCP SDU count is determined, deciphering (step 642), reorder buffering (step 632), PDCP SDU separation (step 622) where the single PDCP PDU is split to multiple IP packets, and ROHC header decompression (step 612). Under PDCP concatenation, a single PDCP PDU may contain multiple IP packets. The PDCP receiver thus needs to split the PDCP PDU to recover individual IP packets that are to be sent to higher layers. Since IP header contains the length field, the PDCP receiver should be able to identify the boundaries of individual IP packets without the need for additional protocol header fields. When ROHC is configured, the PDCP receiver will need to de-compress the first IP packet in the PDCP PDU to detect its length before processing subsequent IP packets in the same PDCP PDU. Alternatively, additional header fields can be used to indicate the length of the IP packets.

In a related embodiment, the eNB may configure PDCP configuration by RRC signaling, MAC control elements, (e)PDCCH order, or a combination thereof. For example, the eNB may configure PDCP concatenation for a particular DRB as part of DRB configuration or modification in RRC signaling. Once PDCP concatenation has been configured, the eNB may activate or deactivate PDCP concatenation via MAC CEs or (e)PDCCH signaling. Note that it is possible to just use RRC signaling to configure PDCP concatenation. It should also be possible to separately configure uplink and downlink PDCP concatenation. In a related embodiment, the eNB may indicate to the UE the number of PDCP SDUs to concatenate (for uplink) and/or number of PDCP PDUs concatenated (for downlink). In addition, the UE may request the level of concatenation to use for uplink and/or downlink. In a related embodiment, there may be no need to explicitly indicate PDCP concatenation with the receiver being able to process concatenated PDCP PDUs that may be transmitted by the transmitter based on processing of IP headers. In a related embodiment, the UE capability may be enhanced to indicate support of PDCP concatenation. It may also be possible for the UE to separately indicate support for uplink and downlink PDCP concatenation, or to use a single value to indicate support for both uplink and downlink PDCP concatenation.

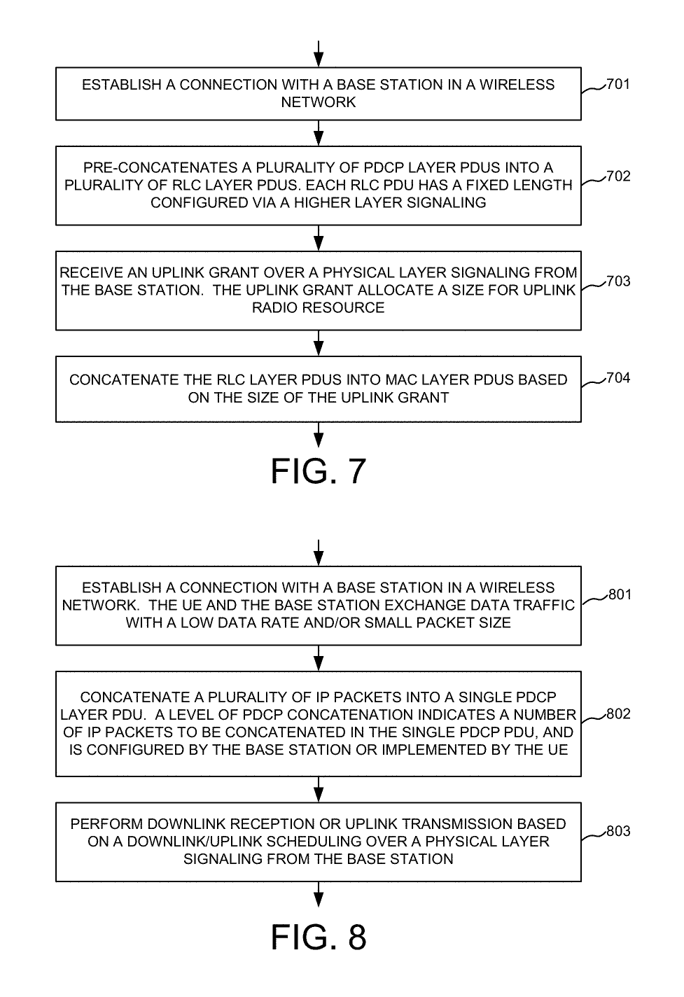

FIG. 7 is a flow chart of a method of pre-concatenation for high speed data traffic in accordance with one novel aspect. In step 701, a UE establishes a connection with a base station in a wireless network. In step 702, the UE pre-concatenates a plurality of packet data convergence protocol (PDCP) layer protocol data units (PDUs) into a plurality of radio link control (RLC) layer PDUs. Each RLC layer PDU has a fixed-length configured via a higher layer signaling. In step 703, the UE receives an uplink grant over a physical layer signaling from the base station. The uplink grant allocates a size for uplink radio resource. In step 704, the UE concatenates the RLC layer PDUs into media access control (MAC) layer PDUs based on the size of the uplink grant.

FIG. 8 is a flow chart of a method of PDCP concatenation for low data rate and/or small packet size in accordance with one novel aspect. In step 801, a UE establishes a connection with a base station in a wireless network. The UE and the base stations exchange data traffic with a low data rate and/or a small packet size. In step 802, the UE concatenates a plurality of IP packets into a single packet data convergence protocol (PDCP) layer protocol data unit (PDU). A level of PDCP concatenation indicates a number of IP packets to be concatenated in the single PDCP PDU, and the level of PDCP concatenation is configured by the base station or implemented by the UE. In step 803, the UE performs downlink reception or uplink transmission based on a downlink/uplink scheduling over a physical layer signaling from the base station.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing a connection by a user equipment (UE) with a base station in a wireless network;
pre-concatenating a plurality of packet data convergence protocol (PDCP) layer protocol data units (PDUs) into a plurality of radio link control (RLC) layer PDUs, wherein each RLC layer PDU having a fixed-length configured via a higher layer signaling;
receiving an uplink grant over a physical layer signaling from the base station, wherein the uplink grant allocates a size for uplink radio resource; and
concatenating the RLC layer PDUs into media access control (MAC) layer PDUs based on the size of the uplink grant.

2. The method of claim 1, wherein the higher layer signaling configures the UE for pre-concatenation for high data rate application traffic.

3. The method of claim 2, wherein the UE performs the pre-concatenation independent from the uplink grant.

4. The method of claim 1, wherein each RLC layer PDU comprises a number of length fields, each length field indicates a length of a corresponding concatenated PDCP layer PDU.

5. The method of claim 1, wherein each MAC layer PDU comprises a field indicating a number of concatenated RLC layer PDUs.

6. A user equipment (UE), comprising:
a configuration circuit that establishes a connection with a base station in a wireless network;
a packet data convergence protocol (PDCP) layer protocol stack that pre-concatenates a plurality of PDCP layer protocol data units (PDUs) into a plurality of radio link control (RLC) layer PDUs, wherein each RLC layer PDU having a fixed-length configured via a higher layer signaling;
a radio frequency (RF) receiver that receives an uplink grant over a physical layer signaling from the base station, wherein the uplink grant allocates a size for uplink radio resource; and
media access control (MAC) layer protocol stack that concatenates the RLC layer PDUs into MAC layer PDUs based on the size of the uplink grant.

7. The UE of claim 6, wherein the higher layer signaling configures the UE for pre-concatenation for high data rate application traffic.

8. The UE of claim 6, wherein the UE performs the pre-concatenation independent from the uplink grant.

9. The UE of claim 6, wherein each RLC layer PDU comprises a number of length fields, each length field indicates a length of a corresponding concatenated PDCP layer PDU.

10. The UE of claim 6, wherein each MAC layer PDU comprises a field indicating a number of concatenated RLC layer PDUs.

11. A method comprising:
establishing a connection by a user equipment (UE) with a base station in a wireless network, wherein the UE and the base stations exchange data traffic with a low data rate and/or a small packet size;
concatenating a plurality of IP packets into a single packet data convergence protocol (PDCP) layer protocol data unit (PDU), wherein a level of PDCP concatenation indicates a number of IP packets to be concatenated in the single PDCP PDU, and wherein the level of PDCP concatenation is configured by the base station or implemented by the UE; and
performing downlink reception or uplink transmission based on a downlink/uplink scheduling over a physical layer signaling from the base station.

12. The method of claim 11, wherein the PDCP concatenation is activated, deactivated, or modified via one of a radio resource control (RRC) signaling, a media access control (MAC) control element (CE), and a physical downlink control channel (PDCCH) order.

13. The method of claim 11, wherein the level of PDCP concatenation is configured per data radio bearer (DRB) and separately for uplink and downlink.

14. The method of claim 11, wherein the UE sends a request to the base station to apply the level of PDCP concatenation.

15. The method of claim 11, wherein UE capability information indicates whether the UE supports PDCP concatenation.

16. A User Equipment (UE) comprising:
a configuration circuit that establishes a connection with a base station in a wireless network, wherein the UE and the base stations exchange data traffic with a low data rate and/or a small packet size;
a packet data convergence protocol (PDCP) layer protocol stack that concatenates a plurality of IP packets into a single PDCP layer protocol data unit (PDU), wherein a level of PDCP concatenation indicates a number of IP packets to be concatenated in the single PDCP PDU, and wherein the level of PDCP concatenation is configured by the base station or implemented by the UE; and
a radio frequency (RF) transceiver that performs downlink reception or uplink transmission based on a downlink/uplink scheduling over a physical layer signaling from the base station.

17. The UE of claim 16, wherein the PDCP concatenation is activated, deactivated, or modified via one of a radio resource control (RRC) signaling, a media access control (MAC) control element (CE), and a physical downlink control channel (PDCCH) order.

18. The UE of claim 16, wherein the level of PDCP concatenation is configured per data radio bearer (DRB) and separately for uplink and downlink.

19. The UE of claim 16, wherein the UE sends a request to the base station to apply the level of PDCP concatenation.

20. The UE of claim 16, wherein UE capability information indicates whether the UE supports PDCP concatenation.
